(19) United States
(12) Patent Application Publication
(10) Pub. No.: US 2008/0319111 A1
(43) Pub. Date: Dec. 25, 2008

(54) Curable, Blocked Polyisocyanate-Based Mixtures Free From Molybdenum and Tungsten Compounds But Containing Cesium Compounds, Their Preparation and Use

(75) Inventors: Marco Deyda, Hamm (DE); Hubert Baumgart, Munster (DE); Bianca Giesen, Hamm (DE); Michael Tecklenborg, Drensteinfurt (DE)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 12/065,114

(22) PCT Filed: Aug. 29, 2006
(86) PCT No.: PCT/EP06/08445

§ 371 Date: Jul. 8, 2008

(30) Foreign Application Priority Data
Aug. 31, 2005 (DE) 10 2005 041 246.7

(51) Int. Cl. C08K 3/10

(52) U.S. Cl. 524/403

(57) ABSTRACT

Curable mixtures free from compounds of molybdenum and of tungsten and comprising
(A) at least one constituent containing blocked isocyanate groups (a1) and isocyanate-reactive functional groups (a2), and
(B) at least one cesium compound;
   processes for preparing them, and their use.

### FIELD OF THE INVENTION

The present invention relates to new, curable mixtures free from compounds of molybdenum and of tungsten, containing cesium compounds, and based on blocked polyisocyanates. The present invention also relates to a new process for preparing curable mixtures free from compounds of molybdenum and of tungsten, containing cesium compounds, and based on blocked polyisocyanates. The present invention further relates to the use of the new, curable mixtures free from compounds of molybdenum and of tungsten, containing cesium compounds, and based on blocked polyisocyanates, and of the mixtures of said kind prepared by the new process.

### PRIOR ART

German patent application DE 103 08 104 A1 discloses one-component baking systems based on blocked polyisocyanate that comprise organic and/or inorganic compounds of molybdenum and/or of tungsten in an oxidation state of at least +4, in particular +6. A great number of suitable compounds is specified, including the molybdates of lithium, sodium, potassium, rubidium, and cesium. The examples use only lithium molybdate, sodium molybdate, and potassium molybdate.

Hence the German patent application does not provide the skilled worker with any incitements or any indications whatsoever to the effect that cesium compounds per se might have particular advantages in one-component baking systems based on blocked polyisocyanates. On the contrary: The examples of the German patent application underline the view that it is specifically not the use of cesium but rather the use of the molybdate anion—quite irrespective of the counterion—which is the important factor.

The compounds of molybdenum and/or of tungsten are said to permit a significant lowering of the baking temperatures.

However, molybdenum and tungsten are known to form, under a very wide variety of different conditions, intensely colored compounds, such as, for example, molybdenum blue, molybdatophosphoric acid (yellow), tungsten blue or tungsten bronzes, of which a number are of great importance for analytical chemistry, such as molybdenum blue as a sensitive indicator of molybdenum, or such as molybdatophosphoric acid as a sensitive indicator of phosphate. With the known use of compounds of molybdenum and/or of tungsten, therefore, there is always a risk that the clearcoats produced from the known one-component baking systems based on blocked polyisocyanates will suffer intense discoloration over time, so making them fundamentally unsuitable for use in automotive OEM finishes, whose specific function is to impart an overall appearance which remains consistently good for many years.

German patent application DE 101 61 156 A1 discloses a process for preparing aqueous polyurethane dispersions using cesium salts as catalysts of the polyaddition of nonblocked polyisocyanates. The resultant aqueous polyurethane dispersions can be used to coat or bond articles made of metals, plastics, paper, textile, leather or wood. For this purpose they may be admixed with hydrophobic auxiliaries, such as polymer-based adhesion promoters, or commercially customary auxiliaries and additives, such as blowing agents, defoamers, emulsifiers, thickeners and thixotropic agents, and also colorants, such as dyes and pigments. The patent application does not reveal whether the catalyst residues, which may still be present in the aqueous polyurethane dispersions, go beyond their original catalytic effect to influence the performance properties of the coating materials and adhesives and of the coatings and adhesive layers produced from them, or not.

### Problem Addressed

The present invention is based on the object of finding new, curable mixtures free from compounds of molybdenum and of tungsten, containing cesium compounds, and based on blocked polyisocyanates (called “new mixtures” hereinbelow) that are no longer to have the disadvantages of the prior art.

In particular the new mixtures ought not to contain any other toxicologically and environmentally objectionable metal compounds, such as organotin compounds, especially dibutyltin dilaurate, in lieu of compounds of molybdenum and of tungsten.

The new mixtures ought to be curable at comparably low temperatures. At the same time they ought to provide very good wetting of the surfaces of any of a very wide variety of substrates; that is, they ought to have a particularly low wetting limit.

The new mixtures ought to provide new, cured materials which on overbaking and on long-term atmospheric exposure no longer exhibit yellowing, which even at high film thicknesses do not have film defects, such as pocks, gel specks, sags, craters or microdefects (“starry sky”), and which exhibit very good leveling, high gloss and low haze, high chemical stability, high weathering stability, and high hardness, high flexibility, and high scratch resistance. Overall they ought readily to attain the so-called automobile quality as defined in European patent EP 0 352 298 B1, page 15, line 42, to page 17, line 40.

### Solution

Found accordingly have been the new, curable mixtures free from compounds of molybdenum and of tungsten and comprising
(A) a complementary reactive system containing blocked isocyanate groups (a1) and isocyanate-reactive functional groups (a2), and
(B) at least one cesium compound,
   which are referred to below as “mixtures of the invention”.

Also found has been the new process for preparing the mixture of the invention, which involves mixing at least constituents (A) and (B) with one another and homogenizing the resulting mixture, and which is referred to below as “process of the invention”.

Found additionally has been the new use of the mixtures of the invention and of the mixtures prepared by the process of the invention as coating materials, adhesives, sealants, and starting products for the production of moldings and sheets, this being referred to below as “use in accordance with the invention”.

### THE ADVANTAGES OF THE INVENTION

In the light of the prior art it was surprising and unforeseeable for the skilled worker that the object on which the present invention was based could be achieved by means of the mixtures of the invention, the process of the invention, and the use in accordance with the invention.

In particular it was surprising that the mixtures of the invention no longer exhibited the disadvantages of the curable mixtures of the prior art.

In particular the mixtures of the invention contained no other toxicologically or environmentally objectionable metal compounds, such as organotin compounds, especially dibutyltin dilaurate, in lieu of the prior art's molybdenum and tungsten compounds. In spite of this they are infested only to a small extent, if at all, by microorganisms.

The mixtures of the invention were able to be cured rapidly without problems at comparatively low temperatures. At the same time they wetted the surfaces of a wide variety of substrates very effectively; that is, they had a particularly low wetting limit.

The mixtures of the invention provided new, cured materials which on overbaking and on long-term atmospheric exposure no longer exhibited yellowing, which even at high film thicknesses did not have film defects, such as pocks, gel specks, sags, craters or microdefects (“starry sky”), and which exhibited very good leveling, high gloss and low haze, high chemical stability, high weathering stability, and high hardness, high flexibility, and high scratch resistance. Overall they readily attained the so-called automobile quality as defined in European patent EP 0 352 298 B1, page 15, line 42, to page 17, line 40.

### DETAILED DESCRIPTION OF THE INVENTION

The mixtures of the invention are free from compounds of molybdenum and of tungsten. This means that the mixtures of the invention contain, at the very most, traces of molybdenum compounds and tungsten compounds, introduced by way of the constituents of the mixtures of the invention. The amount of molybdenum compounds and tungsten compounds is preferably below the detection limits of the customary, known methods of qualitative and quantitative detection of molybdenum and tungsten.

The mixtures of the invention are preferably likewise free of metal compounds, especially compounds of toxicologically and environmentally objectionable metals, especially tin compounds such as, for example, dibutyltin dilaurate.

The mixtures of the invention are curable thermally. This means that they undergo three-dimensional crosslinking via thermally initiated reactions of complementary, reactive functional groups, inventively blocked isocyanate groups (a1) and isocyanate-reactive functional groups (a2), and provide cured thermoset materials.

The thermal cure through the complementary, reactive functional groups (a1) and (a2) may be assisted by further customary, known curing mechanisms. Examples of further curing mechanisms are thermal curing through other complementary, reactive functional groups than the groups (a1) and (a2), physical curing through the filming of film-forming constituents, air drying through the crosslinking of corresponding constituents with oxygen, and curing with actinic radiation, particularly UV radiation or electron beams. These curing mechanisms and methods are additionally employed and serve to modify and optimize the thermal curing to be applied in accordance with the invention through the complementary reactive functional groups (a1) and (a2), which defines the profile of performance properties of the mixtures of the invention and of the materials of the invention produced from them.

The mixtures of the invention comprise a complementary reactive system (A) which encompasses blocked isocyanate groups (a1) and isocyanate-reactive functional groups (a2).

The complementary reactive system (A) may comprise or consist of at least one, especially one, self-crosslinking constituent (A1/2) which contains on average at least two blocked isocyanate groups (a1) and at least one isocyanate-reactive functional group (a2) or at least one blocked isocyanate group (a1) and at least two isocyanate-reactive functional groups (a2).

Preferably the self-crosslinking constituent (A1/2) contains on average 2 to 10, more preferably 2.5 to 6.5, and in particular 3 to 6 blocked isocyanate groups (a1) and 2 to 10, more preferably 2.5 to 6.5, and in particular 3 to 6 isocyanate-reactive functional groups (a2).

Preferably the complementary reactive functional groups (a1) and (a2) in the self-crosslinking constituents (A1/2) are linked to oligomeric and polymeric structural units.

Here and below, oligomers are compounds or structural units which are composed on average of 3 to 12 monomeric structural units, which may be the same as or different from one another.

Here and below, polymers are compounds or structural units which are composed on average of more than 8 monomeric structural units, which may be the same as or different from one another.

Whether a self-crosslinking constituent (A1/2) which is composed on average of 8 to 12 monomeric structural units is regarded by the skilled worker as being an oligomer or a polymer depends in particular on the number-average and mass-average molecular weight of the constituent in question. Where the molecular weights are comparatively high, it will be referred to as a polymer; where they are comparatively low, as an oligomer.

The monomeric structural units of the self-crosslinking constituents (A1/2) are structural units deriving from customary, known organic compounds of low molecular weight.

The oligomers and polymeric structural units of the self-crosslinking constituents (A1/2) derive from the customary, known organic and organometallic oligomers and polymers. Preferably they derive from the oligomers and polymers of the kind usually used as binders (cf. Römpp Lexikon Lacke und Druckfarben, Georg Thieme Verlag, Stuttgart, New York, 1998, “binders”). The oligomers and polymers may have any of a very wide variety of structures. By way of example they may be linear, star-shaped, cone-shaped or irregularly branched, dendrimeric or cyclic, it being possible for more than one of these structures to be present in a self-crosslinking constituent (A1/2). The structures may exhibit a random and/or blockwise distribution of the monomeric structural units.

The complementary reactive system (A) is preferably externally crosslinking, that is, it comprises at least one blocked polyisocyanate (A1) containing at least two blocked isocyanate groups (a1), and at least one constituent (A2) containing on average at least two isocyanate-reactive functional groups (a2), or it consists thereof. With particular preference the complementary reactive system (A) consists of a blocked polyisocyanate (A1) and of a constituent (A2).

In the preferred complementary reactive system the equivalent ratio (i.e., ratio of equivalents) of blocked isocyanate groups (a1) to isocyanate-reactive functional groups (a2) may vary widely. The equivalent ratio (a1):(a2) is preferably close to 1, more preferably 1.5:1 to 1:1.5, very preferably 1.3:1 to 1:1.3 and in particular 1.2:1 to 1:1.2.

The blocked polyisocyanate (A1) preferably contains on average 2 to 10, more preferably 2.5 to 6.5, and in particular 3 to 6 blocked isocyanate groups (a1).

The blocked polyisocyanate (A1) is preferably of low molecular weight or, in the sense outlined above, oligomeric. Its blocked isocyanate groups (a1) are preferably prepared by the reaction of isocyanate groups with blocking agents.

The isocyanate groups are preferably present in the customary, known polyisocyanates.

Examples of suitable, customary, known polyisocyanates are
diisocyanates, such as tetramethylene 1,4-diisocyanate, hexamethylene 1,6-diisocyanate, 2,2,4-trimethylhexamethylene 1,6-diisocyanate, omega,omega′-dipropyl ether diisocyanate, cyclohexyl 1,4-diisocyanate, cyclohexyl 1,3-diisocyanate, cyclohexyl 1,2-diisocyanate, dicyclohexylmethane 4,4-diisocyanate, 1,5-dimethyl 2,4-di(isocyanatomethyl)benzene, 1,5-dimethyl 2,4-di(isocyanatoethyl)benzene, 1,3,5-trimethyl-2,4-di(isocyanatomethyl)benzene, 1,3,5-triethyl-2,4-di(isocyanatomethyl)benzene, isophorone diisocyanate, dicyclohexyldimethylmethane 4,4′-diisocyanate, tolylene 2,4-diisocyanate, tolylene 2,6-diisocyanate, and diphenylmethane 4,4′-diisocyanate; and
polyisocyanates, such as triisocyanates such as nonane triisocyanate (NTI), and also polyisocyanates based on the above-described diisocyanates and triisocyanates, especially oligomers containing isocyanurate, biuret, allophanate, iminooxadiazinedione, urethane, carbodiimide, urea and/or uretdione groups, known for example from patents and patent applications CA 2,163,591 A 1, U.S. Pat. No. 4,419,513 A, U.S. Pat. No. 4,454,317 A, EP 0 646 608 A 1, U.S. Pat. No. 4,801,675 A, EP 0 183 976 A 1, DE 40 15 155 A 1, EP 0 303 150 A 1, EP 0 496 208 A 1, EP 0 524 500 A 1, EP 0 566 037 A 1, U.S. Pat. No. 5,258,482 A, U.S. Pat. No. 5,290,902 A, EP 0 649 806 A 1, DE 42 29 183 A 1 or EP 0 531 820 A 1;
the high-viscosity polyisocyanates as described in German patent application DE 198 28 935 A 1; and also
the polyisocyanates known from German patent application DE 199 24 170 A 1, column 2, line 6 to 34, column 4, line 16, to column 6, line 62, the polyisocyanates known from international patent applications WO 00/31194, page 11, line 30, to page 12, line 26, and WO 00/37520, page 5, line 4, to page 6, line 27, and the polyisocyanates known from European patent application EP 0 976 723 A2, page 12, paragraph [0128], to page 22, paragraph [0284].

Examples of suitable, customary, known blocking agents are
phenols such as phenol, cresol, xylenol, nitrophenol, chlorophenol, ethylphenol, tert-butylphenol, hydroxybenzoic acid, esters of this acid, or 2,5-di-tert-butyl-4-hydroxytoluene;
lactams, such as ε-caprolactam, δ-valerolactam, γ-butyrolactam or β-propiolactam;
active methylenic compounds, such as diethyl malonate, dimethyl malonate, methyl or ethyl acetoacetate or acetylacetone;
alcohols such as methanol, ethanol, n-propanol, isopropanol, n-butanol, isobutanol, tert-butanol, n-amyl alcohol, t-amyl alcohol, and lauryl alcohol, ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxy-methanol, glycolic acid, glycolic esters, lactic acid, lactic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;
mercaptans such as butyl mercaptan, hexyl mercaptan, tert-butyl mercaptan, tert-dodecyl mercaptan, 2-mercaptobenzothiazole, thiophenol, methylthiophenol or ethylthiophenol;
acid amides such as acetoanilide, acetoanisidinamide, acrylamide, methacrylamide, acetamide, stearamide or benzamide;
imides such as succinimide, phthalimide or maleimide;
amines such as diphenylamine, phenylnaphthylamine, xylidine, N-phenylxylidine, carbazole, aniline, naphthylamine, butylamine, dibutylamine or butylphenylamine;
imidazoles such as imidazole or 2-ethylimidazole;
ureas such as urea, thiourea, ethyleneurea, ethylenethiourea or 1,3-diphenylurea;
carbamates such as phenyl N-phenylcarbamate or 2-oxazolidone;
imines such as ethyleneimine;
oximes such as acetone oxime, formaldoxime, acetaldoxime, acetoxime, methyl ethyl ketoxime, diisobutyl ketoxime, diacetyl monoxime, benzophenone oxime or chlorohexanone oximes;
salts of sulfurous acid such as sodium bisulfite or potassium bisulfite;
hydroxamic esters such as benzyl methacrylohydroxamate (BMH) or allyl methacrylohydroxamate;
pyrazole or substituted pyrazoles, especially 3,4- or 3,5-dimethylpyrazole, or triazoles; or
mixtures of these blocking agents, especially 3,4- or 3,5-dimethylpyrazole and triazoles, malonic esters and acetoacetic esters, or 3,4- or 3,5-dimethylpyrazole and succinimide.

Preferably constituent (A2) contains on average at least 2, more preferably at least 3, and in particular at least 4 isocyanate-reactive functional groups (a2).

The isocyanate-reactive functional groups (a2) are preferably selected from the group consisting of hydroxyl groups, thiol groups, primary and secondary amino groups, primary and secondary amide groups, and primary and secondary carbamate groups.

Hydroxyl groups (a2) are used in particular.

The hydroxyl groups (a2) are present in the constituents (A2) preferably in a number such as to result in hydroxyl numbers of 50 to 500, more preferably 80 to 300, and in particular 100 to 250 mg KOH/g.

Besides the isocyanate-reactive functional groups (a2) the constituents (A2) may further include other reactive functional groups which are not isocyanate-reactive but are able to enter into thermal crosslinking reactions with complementary reactive functional groups. Examples of suitable pairings of complementary reactive functional groups that are not isocyanate-reactive are known from international patent application WO 03/010247, page 18, line 12, to page 21, line 15.

The constituents (A2) may further include ion-forming functional groups which by neutralization can be converted into salt groups and which as a result are able to effect ionic stabilization in water. Examples of suitable ion-forming functional groups are likewise known from international patent application WO 03/010247, page 12, line 9, to page 13, line 11.

Furthermore, the constituents (A2) may also include reactive functional groups which can be activated with actinic radiation, especially UV radiation and electron beams. Examples of suitable groups of this kind are also known from international patent application WO 03/010247, page 23, line 29, to page 26, line 4.

The constituents (A2) are preferably oligomers or polymers in the sense outlined above. More preferably they are selected from the group of the customary, known binders. Examples of suitable binders (A2) are known from international patent application WO 03/010247, page 13, line 13, to page 15, line 8. (Meth)acrylate copolymers (A2) are used in particular.

The mixtures of the invention comprise at least one cesium compound, in particular at least one cesium salt (B).

The anions of the cesium salts are preferably selected from the group consisting of F⁻, Cl⁻, ClO—, ClO₃⁻, ClO₄⁻, Br⁻, I⁻, IO₃⁻, CN⁻, OCN⁻, SCN⁻, NO₂⁻, NO₃⁻, CO₃²⁻, SiO₄²⁻, SiF₆²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, R(—SO₃²⁻)ₙ, H₂PO₂⁻, H₂PO₃⁻, HPO₃²⁻, R(—PHO₃⁻)ₙ, R(—PO₃²⁻)ₙ, H₂PO₄⁻, HPO₄²⁻, PO₄³⁻, P₂O₇⁴⁻, PF₆³⁻, R(—O⁻)ₙ, and R(—COO⁻)ₙ, in which the variable R stands for n-valent organic radicals and n is a number from 1 to 100, more preferably 1 to 50, very preferably 1 to 30, and in particular 1 to 20.

Accordingly the n-valent organic radicals R are of low molecular weight, oligomeric or polymeric, in the sense outlined above, especially of low molecular weight.

The organic radicals R are preferably selected from the group consisting of:
n-valent, substituted and unsubstituted alkyl having 1 to 20, preferably 2 to 16, and in particular 2 to 10 carbon atoms, cycloalkyl having 3 to 20, preferably 3 to 16, and in particular 3 to 10 carbon atoms, and aryl having 5 to 20, preferably 6 to 14, and in particular 6 to 10 carbon atoms;
n-valent, substituted and unsubstituted alkylaryl, arylalkyl, alkylcycloalkyl, cycloalkylalkyl, arylcycloalkyl, cycloalkylaryl, alkylcycloalkylaryl, alkylarylcycloalkyl, arylcycloalkylalkyl, arylalkylcycloalkyl, cycloalkylalkylaryl, and cycloalkylarylalkyl radical, the alkyl, cycloalkyl, and aryl groups present therein each containing the above-recited number of carbon atoms; and
n-valent, substituted and unsubstituted radical of the above-recited kind containing at least one, especially one, heteroatom selected from the group consisting of oxygen atom, sulfur atom, nitrogen atom, phosphorus atom, and silicon atom, especially oxygen atom, sulfur atom, and nitrogen atom.

Suitable substituents for the radicals R include all groups and atoms which are inert, i.e., which do not detract from the activity of the cesium salts (B), do not inhibit the curing reactions in the mixtures of the invention, do not lead to unwanted side reactions, and do not give rise to any toxic effect. Examples of suitable substituents are halogen atoms, nitrile groups or nitro groups, preferably halogen atoms, especially fluorine atoms, chlorine atoms, and bromine atoms.

The anions are selected in particular from the group consisting of hydrogencarbonate, carbonate, formate, acetate, propionate, butyrate, pentanoate, hexanoate, and 2-ethylhexanoate.

The amount of the cesium compounds (B) in the mixtures of the invention may vary widely and is guided by the requirements of the case in hand. Preferably the mixtures of the invention comprise the cesium compounds (B) in an amount of 0.01 to 10% by weight, more preferably 0.05% to 5% by weight, and in particular 0.1% to 3% by weight, based in each case on the solids of the mixture of the invention in question.

Here and below, “solids” means the sum of all constituents of a mixture of the invention minus any organic and inorganic solvents (C) that may be present. Accordingly, “solids content” of a mixture of the invention is to be understood as meaning the percentage fraction of the solids as a proportion of the total amount of the mixture of the invention.

Accordingly the solids content of the mixtures of the invention can amount to 100% by weight. Where the mixtures of the invention include organic and/or inorganic solvents (C) the solids content is preferably 10% to 90%, more preferably 15% to 80%, very preferably 20% to 70%, and in particular 20% to 60% by weight.

As mentioned above, the mixtures of the invention may further comprise at least one additive (C) in effective amounts.

The additive (C) is preferably selected from the group consisting of reactive and inert, oligomeric and polymeric, film-forming binders other than the constituents (A); crosslinking agents other than the constituents (A); water; reactive and inert, organic and inorganic solvents; compounds which can be activated with actinic radiation, especially UV radiation and electron beams; organic and inorganic, colored and achromatic, optical effect, electrically conductive, magnetically shielding, and fluorescent pigments; transparent and opaque, organic and inorganic fillers; nanoparticles; UV absorbers; light stabilizers; free-radical scavengers; photoinitiators; free-radical polymerization initiators; driers; devolatilizers; slip additives; polymerization inhibitors; defoamers; emulsifiers and wetting agents; adhesion promoters; flow control agents; film-forming auxiliaries; rheology control additives; and flame retardants.

Examples of suitable additives (C) which can be used in particular in aqueous mixtures of the invention are known from international patent application WO 03/010247, page 9, line 16, to page 10, line 19, and page 26, line 27, to page 35, line 2.

Further examples of suitable additives (C) are known from German patent application DE 199 48 004 A1, page 14, lines 4 to 31, and page 16, line 24, to page 17, line 5.

The mixtures of the invention may be present in any of a very wide variety of physical states and three-dimensional forms.

For instance, the mixtures of the invention may be solid or liquid, or fluid, at room temperature. Alternatively they may be solid at room temperature and fluid at higher temperatures, in which case they preferably exhibit thermoplastic behavior. In particular they may be conventional mixtures containing organic solvents, aqueous mixtures, substantially or entirely solvent- and water-free liquid mixtures (100% systems), substantially or entirely solvent- and water-free solid powders, or substantially or entirely solvent-free aqueous powder suspensions (powder slurries).

Preferably they are substantially or entirely solvent-free aqueous powder suspensions (powder slurries), especially powder slurry clearcoat materials, such as are known—apart from the inventive use of the cesium compounds (B)—from international patent application WO 03/010247 or from German patent DE 198 41 842 C2.

In terms of method the preparation of the mixtures of the invention has no peculiarities but instead takes place, in the context of the process of the invention, by the mixing and homogenizing of the above-described constituents using customary, known mixing methods and apparatus such as stirred tanks, agitator mills, extruders, compounders, Ultraturrax, inline dissolvers, static mixers, micromixers, toothed-wheel dispersers, pressure release nozzles and/or microfluidizers, where appropriate in the absence of actinic radiation. The selection of the optimum method for any given case depends in particular on the physical state and three-dimensional form which the mixture of the invention is to have. Where, for example, a thermoplastic mixture of the invention is to be in the form of a sheet or laminate, extrusion through a slot die is particularly appropriate for the preparation of the mixture of the invention and its shaping.

In this context the powder slurries of the invention, in particular, can be prepared by means of the secondary dispersion methods, as described for example in international patent application WO 03/010247, page 35, line 4, to page 38, line 19, or in German patent DE 198 41 842 C2, page 5, line 43, to page 6, line 3. It is, however, also possible to employ the melt emulsification methods, as described for example in German patent application DE 101 26 652 A1, page 4, paragraph [0040], to page 5, paragraph [0058].

In the context of the use in accordance with the invention the mixtures of the invention are used to produce new, cured materials, especially new thermoset materials, which serve any of a very wide variety of end uses and are referred to below as “materials of the invention”.

The mixtures of the invention are preferably starting products for moldings and sheets or are coating materials, adhesives, and sealants, especially coating materials.

The materials of the invention are preferably new moldings, sheets, coatings, adhesive layers, and seals, especially new coatings.

The coating materials of the invention are employed preferably as new electrocoat materials, surfacers, antistonechip primers, solid-color topcoat, aqueous basecoat and/or clearcoat materials, very preferably clearcoat materials, especially powder slurry clearcoat materials, for producing new, color and/or effect, electrically conductive, magnetically shielding or fluorescent multicoat paint systems, especially multicoat color and/or effect paint systems. For producing the multicoat paint systems of the invention it is possible to employ the customary, known wet-on-wet methods and/or extrusion methods and also the customary, known paint or sheet systems.

For producing the materials of the invention the mixtures of the invention are applied to customary, known temporary or permanent substrates.

For producing the sheets and moldings of the invention it is preferred to use customary, known temporary substrates, such as metallic and polymeric belts and films or hollow bodies made of metal, glass, plastic, wood or ceramic, which are easily removable without damaging the sheets and moldings of the invention produced from the mixtures of the invention.

Where the mixtures of the invention are used for producing the coatings, adhesive layers, and seals of the invention, permanent substrates are employed, such as bodies of means of transport, especially motor-vehicle bodies, and parts thereof, the interior and exterior of buildings and parts thereof, doors, windows, furniture, hollow glassware, coils, containers, packaging, small parts, optical, mechanical, and electrical components, and components for white goods. The sheets and moldings of the invention may likewise serve as permanent substrates.

In terms of method the application of the mixtures of the invention has no peculiarities but may instead take place by all customary, known application methods that are suitable for the respective mixture of the invention, such as extrusion, electrodeposition coating, injecting, spraying, including powder spraying, knifecoating, spreading, pouring, dipping, trickling or rolling. Preference is given to employing extrusion and spray application methods, especially spray application methods.

Following their application the mixtures of the invention are cured thermally in conventional manner.

Thermal curing takes place generally after a certain rest period or flash-off time. This may have a duration of 30 s to 2 h, preferably 1 min to 1 h, and in particular 1 to 45 min. The rest period serves, for example, for the flow and devolatilization of films of the mixtures of the invention, and for the evaporation of volatile constituents such as any solvent and/or water present. Flashing off may be accelerated by an increased temperature, but still below the cure temperature, and/or by a reduced atmospheric humidity.

This procedural measure is also employed for drying the applied mixtures of the invention, especially the films of the coating materials of the invention, more particularly the films of the coats of the invention that are not to be cured or are to be only partly cured.

The thermal cure takes place for example with the aid of a gaseous, liquid and/or solid, hot medium, such as hot air, heated oil or heated rollers, or of microwave radiation, infrared light and/or near infrared (NIR) light. Heating preferably takes place in a forced-air oven or by exposure to IR and/or NIR lamps. Curing may also take place in stages. The thermal cure takes place preferably at temperatures from room temperature to 200° C., more preferably from room temperature to 180° C., and in particular from room temperature to 160° C.

The thermal cure may additionally be assisted by the additional curing methods described above, using where appropriate the customary, known apparatus, for curing for example with actinic radiation, especially UV radiation or electron beams.

The resulting materials of the invention, especially the resulting sheets, moldings, coatings, adhesive layers, and seals of the invention, are outstandingly suitable for the coating, bonding, sealing, wrapping, and packaging of bodies of means of transport, especially motor-vehicle bodies, and parts thereof, the interior and exterior of buildings and parts thereof, doors, windows, furniture, hollow glassware, coils, containers, packaging, small parts, such as nuts, bolts, wheel rims or hubcaps, optical components, mechanical components, electrical components, such as windings (coils, stators, rotors), and also components for white goods, such as radiators, domestic appliances, refrigerator casings or washing-machine casings.

The mixtures of the invention offer very particular advantages if they are used as powder slurry clearcoat materials of the invention for producing new clearcoats.

The clearcoats of the invention usually constitute the outermost coats of multicoat paint systems or of sheets or laminates, which substantially determine the overall appearance and protect the substrates and/or the color and/or effect coats of multicoat paint systems, or sheets or laminates, against mechanical, chemical, and radiation-induced damage. Consequently, deficiencies in hardness, scratch resistance, chemical resistance, and yellowing stability in the clearcoat are also manifested to a particularly severe extent. The clearcoats of the invention that are produced, though, exhibit only little yellowing. They are highly scratch resistant and, after suffering scratching, exhibit only very low losses of gloss. In particular the loss of gloss in the Amtec/Kistler carwash simulation test is very low. At the same time the clearcoats have a high level of hardness and a particularly high chemical resistance. Not least they exhibit outstanding substrate adhesion and intercoat adhesion. Furthermore, they have an outstanding overcoatability.

### EXAMPLES

### Preparation Example 1

### The Preparation of the Methacrylate Copolymer (A2)

39.75 parts by weight of methyl ethyl ketone were charged to a reaction vessel equipped with stirrer, reflux condenser, oil heating, nitrogen inlet tube, and two feed vessels, and this initial charge was heated to 78° C.

Thereafter an initiator solution of 4 parts by weight of methyl ethyl ketone and 5 parts by weight of TBPEH was metered from the first feed vessel at a uniform rate over the course of 6.75 h.

15 minutes after the beginning of the initiator feed a monomer mixture of 27.5 parts by weight of n-butyl methacrylate, 9.15 parts by weight of isobutyl methacrylate, 12.75 parts by weight of hydroxyethyl methacrylate and 0.6 part by weight of methacrylic acid was metered from the second feed vessel at a uniform rate over the course of 6 h. Subsequently the monomer line was flushed with 0.25 part by weight of methyl ethyl ketone and the feed vessel was rinsed with 0.5 part by weight of methyl ethyl ketone. After the end of the initiator feed the feed vessel in question was likewise rinsed with 0.5 part by weight of methyl ethyl ketone.

The reaction mixture was left to after-react at 78° C. for a further 3 h. Thereafter the volatile fractions were removed by vacuum distillation until a solids content of 70% by weight had been set. The resin solution was subsequently discharged. It had a viscosity of 7.0 to 10.0 dPas (resin solids, 60 percent in xylene, at 23° C.). The acid number was 9.0 to 11.0 and the hydroxyl number was 110 mg KOH/g resin solids.

### Preparation Example 2

### The Preparation of the Blocked Polyisocyanate (A1)

534 parts by weight of Desmodur® N 3300 (commercial isocyanurate of hexamethylene diisocyanate, from Bayer AG) and 200 parts by weight of methyl ethyl ketone were charged to a reaction vessel and this initial charge was heated to 40° C. 100 parts by weight of 2,5-dimethylpyrazole were added to the solution, with cooling, and the subsidence of the exothermic reaction was awaited. Thereafter, with continued cooling, a further 100 parts by weight of 3,5-dimethylpyrazole were added. After the exothermic reaction had again subsided, a further 66 parts by weight of 3,5-dimethylpyrazole were added. The cooling was then shut off, as a result of which the reaction mixture slowly heated up to 80° C. It was maintained at this temperature until its isocyanate content had dropped to below 0.1%. Thereafter the reaction mixture was cooled and discharged.

The resulting solution of the blocked polyisocyanate had a solids content of 81% by weight (1 h at 130° C.) and a viscosity of 3.4 dPas (70 percent in methyl ethyl ketone; cone and plate viscometer at 23° C.).

### Example 1

### The preparation of the Inventive Powder Slurry Clearcoat Material

961.8 parts by weight of the methacrylate copolymer solution (A2) from Preparation example 1 and 484.6 parts by weight of the solution of the blocked polyisocyanate (A1) from Preparation example 2 were mixed with one another in an open stirred vessel at room temperature for 15 minutes. Added to the resulting mixture were 21.5 parts by weight of Tinuvin® 400 and 10.7 parts by weight of Tinuvin® 123 (commercial light stabilizers from Ciba Specialty Chemicals, Inc.) and 15 parts by weight of Lutensol® AT 50 (ethoxylated alcohol having 16 to 18 carbon atoms in the alkyl radical and on average 50 ethylene oxide groups in the molecule, from BASF Aktiengesellschaft), after which the mixture was stirred at room temperature for 30 minutes. Subsequently, in addition, 11.3 parts by weight of a 30 percent strength aqueous solution of cesium carbonate and 4.68 parts by weight of dimethylethanolamine were added. The resulting mixture was stirred at room temperature for a further two hours.

It was subsequently admixed with 735 parts by weight of deionized water in which 1.462 parts by weight of ammonium acetate had been dissolved, the admixture taking place in small portions. After a 15-minute interval a further 780 parts by weight of deionized water were added thereto at a uniform rate over the course of 30 minutes.

The resulting aqueous emulsion was diluted with 739 parts by weight of deionized water. Thereafter the same amount of a mixture of volatile organic solvents and water was removed from it under reduced pressure on a rotary evaporator, until the solids content was 37% by weight (1 h at 130° C.)

To impart the desired structural viscosity, 90 parts by weight of Acrysol® RM-8W (commercial nonionic associative thickener from Rohm & Haas) and 1.57 parts by weight of Baysilon® AI 3468 (commercial flow control agent from Bayer AG) were stirred into the slurry.

### Example 2

### The Production of Multicoat Paint Systems 1

The multicoat paint systems 1 were produced using metal test panels which had been coated with a customary, known, cathodically deposited and thermally cured electrocoat from BASF Coatings AG.

The electrocoats were coated, in each case wet-on-wet, with a commercial waterborne surfacer from BASF Coatings AG and with a commercial black aqueous basecoat material from BASF Coatings AG. After each application the wet films in question were subjected to preliminary drying.

To determine the popping limit and the wetting limit, the predried, black aqueous basecoat films were pneumatically coated in a wedge form with the powder slurry clearcoat material 1 from Example 1. The wet film thicknesses of the clearcoat films 1 were in each case chosen so as to result in dry film thicknesses of 15 to 70 μm. The clearcoat films 1 were each subjected to preliminary drying at 80° C. for 10 minutes. Thereafter the surfacer films, the aqueous basecoat films, and the clearcoat films 1 were baked at 150° C. for 23 minutes.

Over the coated area, pops appeared only from a dry film thickness of 51 μm upward. The wetting limit was situated at a dry film thickness of 19 μm. This underscored the fact that the clearcoat 1 wetted the substrates very effectively and exhibited an outstanding popping limit over the coated area.

For assessing the chemical resistance, the gloss, and the flow, the procedure described above was repeated except that the powder slurry clearcoat material 1 was applied in a constant wet film thickness to result in a dry film thickness of 40 μm.

The chemical resistance was determined conventionally using a DC gradient oven. Visible damage occurred for exposure to 1% strength sulfuric acid at 46° C. upward, to 1% strength NaOH at 55° C. upward, to tree resin at 38° C. upward, and deionized water at 41° C. upward. This underscored the fact that the clearcoat 1 also exhibited a high chemical resistance.

The gloss and haze were determined in accordance with DIN 67530. Gloss (20°, 83 units) and haze (20°, 13.6 units) were very good.

The flow was very good (instrument: Byk/Gardner—Wave scan plus: longwave: 2.8; shortwave: 15.5).

The dynamomechanical properties of the clearcoat 1 were determined on the basis of self-supporting films with a thickness of 40 μm, by means of dynamomechanical thermal analysis (DMTA). The measurement frequency was 1 Hz, the amplitude 0.2%, and the heating rate 2° C./min from −30° C. to +200° C. (cf. also German patent application DE 102 24 381 A1, page 5, paragraph [0047]). The values measured were as follows:
loss factor tangent delta=0.1 at 48° C.;
maximum loss factor tangent delta at 83° C.;
loss modulus E″ (max) at 63° C.; and
storage modulus E′(min)=1.4×10⁷.

The values measured underscore the outstanding hardness, flexibility, crosslinking density, and scratch resistance of the clearcoat 1.

1. A curable mixture free from compounds of molybdenum and of tungsten and comprising
(A) a complementary reactive system comprising blocked isocyanate groups (a1) and isocyanate-reactive functional groups (a2), and
(B) at least one cesium compound.

2. The curable mixture free from compounds of molybdenum and of tungsten of claim 1, wherein the cesium compounds are cesium salts.

3. The curable mixture free from compounds of molybdenum and of tungsten of claim 1, wherein the cesium salts comprise anions selected from the group consisting of F⁻, Cl⁻, ClO⁻, ClO₃⁻, ClO₄⁻, Br⁻, I⁻, IO₃⁻, CN⁻, OCN⁻, SCN⁻, NO₂⁻, NO₃⁻, HCO₃⁻, CO₃²⁻, SiO₄²⁻, SiF₆²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, R(—SO₃⁻)ₙ, H₂PO₂⁻, H₂PO₃⁻, HPO₃^{2-, R(—PHO}₃⁻)ₙ, R(—PO₃²⁻)ₙ, H₂PO₄⁻, HPO₄²⁻, PO₄³⁻, P₂O₇⁴⁻, PF₆³⁻, R(—O⁻)ₙ, and R(—COO⁻)ₙ, in which the variable R stands for n-valent organic radicals and n is a number from 1 to 10.

4. The curable mixture free from compounds of molybdenum and of tungsten of claim 1, wherein the complementary reactive system (A) comprises at least one self-crosslinking constituent (A1/2) which comprises on average at least two blocked isocyanate groups (a1) and at least one isocyanate-reactive functional group (a2) or at least one blocked isocyanate group (a1) and at least two isocyanate-reactive functional groups (a2).

5. The curable mixture free from compounds of molybdenum and of tungsten of claim 1, wherein the complementary reactive system (A) comprises at least one blocked polyisocyanate (A1) comprising at least two blocked isocyanate groups (a1), and at least one constituent (A2) comprising on average at least two isocyanate-reactive functional groups (a2).

6. The curable mixture of claim 1, wherein the blocked isocyanate groups (a1) are prepared by reacting isocyanate groups with blocking agents selected from the group consisting of phenols lactams, active methylenic compounds, alcohols, mercaptans, acid amides imides amines, imidazoles, ureas carbamates, imines, oximes, salts of sulfurous acid, hydroxamic esters pyrazoles, and triazoles.

7. (canceled)

8. The curable mixture free from compounds of molybdenum and of tungsten of claim 1, wherein the blocked isocyanate groups (a1) are prepared by reacting isocyanate groups with blocking agents selected from substituted pyrazoles.

9. The curable mixture free from compounds of molybdenum and of tungsten of claim 1, wherein isocyanate-reactive functional groups (a2) are selected from the group consisting of hydroxyl groups, thiol groups, primary and secondary amino groups, primary and secondary amide groups, and primary and secondary carbamate groups.

10. The curable mixture free from compounds of molybdenum and of tungsten of claim 1, wherein the isocyanate-reactive functional groups (a2) are hydroxyl groups.

11. The curable mixture free from compounds of molybdenum and of tungsten of claim 5, wherein the at least one constituents (A2) is an oligomer or a polymer.

12. The curable mixture free from compounds of molybdenum and of tungsten of claim 5, wherein the at least one blocked polyisocyanate (A1) is a low molecular weight compound or oligomer.

13. The curable mixture free from compounds of molybdenum and of tungsten of claim 1, wherein the further comprising at least one additive (C).

14. The curable mixture free from compounds of molybdenum and of tungsten of claim 13, wherein the additive (C) is selected from the group consisting of reactive and inert, oligomeric and polymeric, film-forming binders other than the complementary reactive system (A); crosslinking agents other than the complementary reactive system (A); water; reactive and inert, organic and inorganic solvents; compounds which can be activated with actinic radiation, especially UV radiation and electron beams; organic and inorganic, colored and achromatic, optical effect, electrically conductive, magnetically shielding, and fluorescent pigments; transparent and opaque, organic and inorganic fillers; nanoparticles; UV absorbers; light stabilizers; free-radical scavengers; photoinitiators; free-radical polymerization initiators; driers; devolatilizers; slip additives; polymerization inhibitors; defoamers; emulsifiers and wetting agents; adhesion promoters; flow control agents; film-forming auxiliaries; rheology control additives; and flame retardants.

15. The curable mixture free from compounds of molybdenum and of tungsten of claim 1, comprising the cesium compound (B) in an amount of 0.01 to 10% by weight, based on a total solids content of the mixture.

16. The curable mixture free from compounds of molybdenum and of tungsten of claim 1, having a solids content of 10 to 100% by weight.

17. The curable mixture free from compounds of molybdenum and of tungsten of claim 1, further comprising water.

18. The curable mixture free from compounds of molybdenum and of tungsten of claim 17, in the form of an aqueous dispersion of finely divided dimensionally stable particles.

19. The curable mixture free from compounds of molybdenum and of tungsten of claim 18, wherein the aqueous dispersion is a powder slurry.

20. The curable mixture free from compounds of molybdenum and of tungsten of claim 17, exhibiting structural viscosity.

21. A process for preparing the curable mixture free from compounds of molybdenum and of tungsten of claim 1, comprising mixing the complementary reactive system (A) and the at least one cesium compound (B), and optionally at least one additive (C), with one another and homogenizing the resulting mixture.

22. The process for preparing the curable mixture free from compounds of molybdenum and of tungsten of claim 21, wherein at least the complementary reactive system (A) is dispersed in the form of finely divided dimensionally stable particles in either water or an aqueous medium, and the resulting mixture is homogenized.

23. The curable mixture free from compounds of molybdenum and of tungsten of claim 1, in the form of a coating material, adhesive, sealant or starting product for sheets and moldings or for producing coatings, adhesive layers, seals, sheets, and moldings.
